(19) United States
(12) Patent Application Publication
(10) Pub. No.: US 2007/0031181 A1
(43) Pub. Date: Feb. 8, 2007

(54) Systems and methods for binding documents and papers

(76) Inventor: Robert Rivera, San Juan, TX (US)

Correspondence Address: PATRICK STELLITANO, 2803 INRIDGE DR., AUSTIN, TX, 78745, US

(21) Appl. No.: 11/179,103

(22) Filed: Jul. 12, 2005

(51) Int. Cl. B42F 13/12

(52) U.S. Cl. 402/60

(57) ABSTRACT

Systems, methods and media for binding papers are disclosed. Two opposing frames are so situated that an edge of papers may be inserted between facing sides of the frames and bound by a clamping mechanism. The clamping mechanism comprises a strap secured to the first frame and securable to the second frame. A lever arm, to which the strap is attached, tightens the strap connecting the first and second frames, so that rotating the lever arm tightens the strap, secures the strap to the second frame, and forces the two frames toward each other to clamp an edge of the papers inserted between the frames.

### FIELD

The present invention is in the field of binding documents and papers.

### BACKGROUND

Many familiar products provide for binding or storing documents and paper in a notebook or folder. Examples are the three-ring binder, two-hole flat file folders, pocket folders, spiral notebooks, etc. Each of these prior art document holders have disadvantages. For example, the three-ring binder and the two-hole flat file folder require paper with punched holes. Punching holes into paper can be time consuming. Some documents, such as magazines are difficult to hole-punch. Further, some papers may be misaligned if not hole-punched accurately. Also, the paper wears around the holes and may tear, rendering them unbind-able in a ring binder or two-hole flat file folder. Moreover, some documents can not have holes punched in them because there is no room in the margin and punching a hole would punch out text in the document. A spiral notebook also has disadvantages. For example, papers cannot be easily added to the spiral binder. Removing a sheet from the spiral binder tears the sheet along its perforated edge. Pocket folders can hold documents but the documents do not remain in place within the pocket and can fall out and bend on the edges. What is needed is a document binder that overcomes these and other disadvantages of the prior art.

### SUMMARY

The problems identified above are in large part addressed by an apparatus and method for binding documents and papers. One embodiment comprises two opposing frames so situated that an edge of papers and documents to be bound may be clamped between the facing sides of the frames by a clamping mechanism. The clamping mechanism comprises a strap secured to the first frame and securable to the second frame. A lever arm connected to the strap tightens the strap connecting the first and second frames; so that rotating the lever arm tightens the strap, secures the strap to the second frame, and forces the two frames toward each other to clamp an edge of the papers inserted between the frames. In one embodiment, a lever block is so situated between the strap and a frame that tightening the strap applies force through the lever block to the frame

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an embodiment of a folder with parallel frames between which an edge of papers can be clamped.

FIG. 2 depicts an embodiment of a first frame.

FIG. 3 depicts an embodiment of a second frame.

FIG. 4 depicts an embodiment of frames and a clamping mechanism

FIG. 5 depicts an embodiment of a lever connected to a strap.

FIG. 6 depicts an embodiment of a lever arm connected to a strap in proximity to grooves.

FIG. 7 depicts an embodiment of a lever arm fitting at an end into grooves.

FIG. 8 depicts an embodiment of a frame, lever block and strap anchoring mechanism.

FIG. 9 depicts an embodiment of a strap anchoring mechanism.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Systems, methods and media for binding papers are disclosed. Two opposing frames are so situated that an edge of papers may be inserted between facing sides of the frames and bound by a clamping mechanism. The clamping mechanism comprises a strap secured to the first frame and securable to the second frame. A lever arm, to which the strap is attached, tightens the strap connecting the first and second frames, so that rotating the lever arm tightens the strap, secures the strap to the second frame, and forces the two frames toward each other to clamp an edge of the papers inserted between the frames.

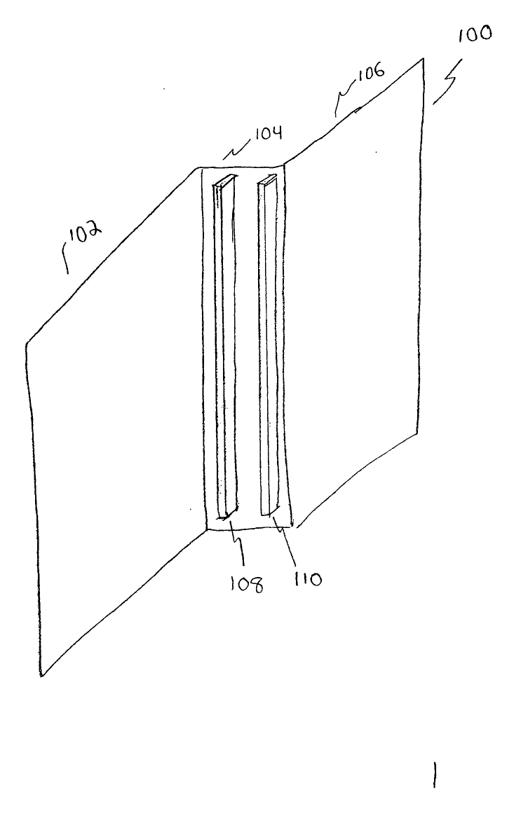

FIG. 1 shows a simplified perspective view of an embodiment of a document binder. A folder 100 comprises a front cover 102, a spine 104 and a back cover 106. In proximity to spine 104 are a first frame 108 and a second frame 110. The facing surfaces of frames 108 and 110 are flat and smooth. Document edges are inserted between the frames and the frames bind the document edges there between. More specifically, the documents are bound by a mechanism for forcing the two frames toward each other to clamp the document edges inserted there between. A clamping mechanism is not shown in FIG. 1 for simplicity of illustration. However, embodiments of clamping mechanisms are herein described.

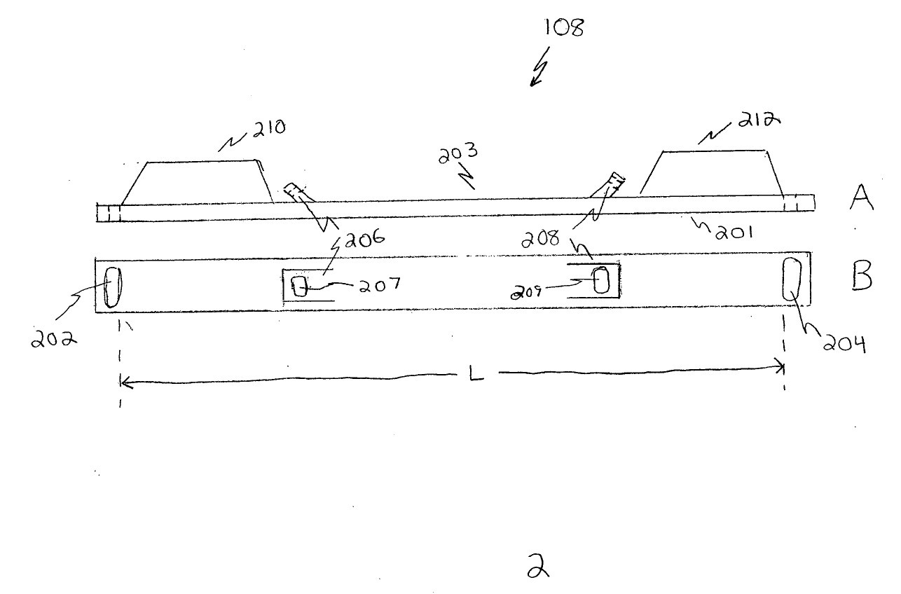

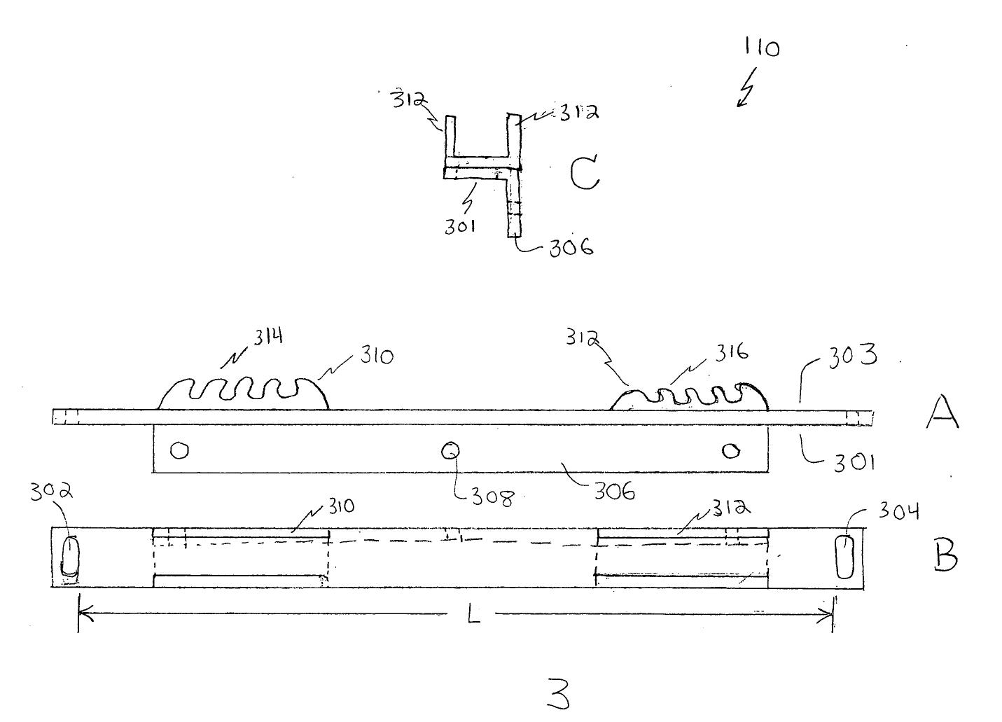

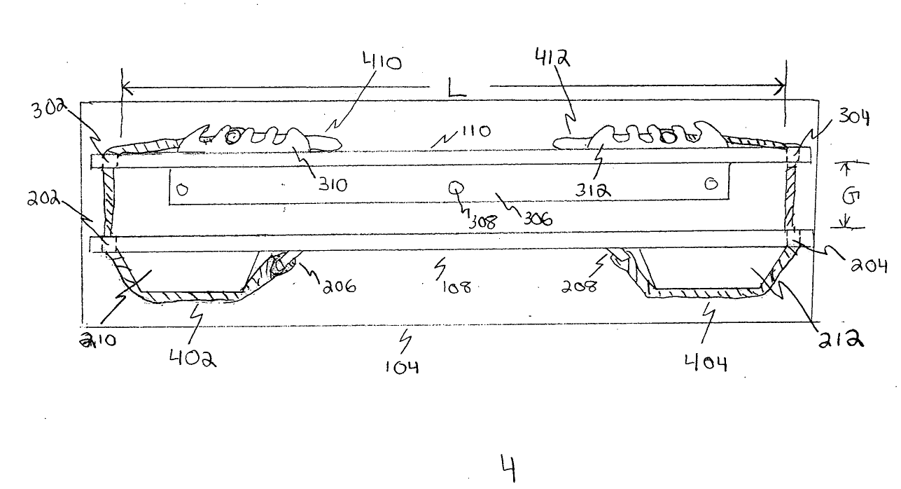

FIG. 2 shows a detailed view of a first frame 108 with a first set of components of a clamping mechanism and FIG. 3 shows a detailed view of a second frame 110 with a second set of components of the clamping mechanism. FIG. 4 shows a detailed view of frames 108 and 110 bound together by a third set of components of the clamping mechanism. Referring now to FIG. 2, a frame 108 has a side view A and a top view B. Frame 108 comprises a first side 201 facing the paper and a second side 203. Frame 108 has rectangular holes 202 and 204, one on each end. Each hole is dimensioned so that a strap may pass through. Side 203 has two lever blocks 210 and 212 symmetrically positioned one near each end. On the inward side of each lever block is a fastening anchor 206, 208, respectively. In each fastening anchor is a rectangular hole 207, 209 through which a strap or a flat hook may pass.

Referring now to FIG. 3, a frame 110 has a side view A, a bottom view B and an end view C. Frame 110 comprises a first side 301 facing the paper and a second side 303. Frame 110 has rectangular holes 302 and 304, one on each end. Each hole is dimensioned so that a strap may pass through. Frame 110 has a securing part 306 with holes 308 for rivets to secure the frame 110 to spine 104 of folder 100. Frame 110 also has sets 310 and 312 of latch grooves exhibiting teeth 314 and 316. Latch grooves and teeth extend outward from side 303 on each edge of frame 110, as shown in end view C and top view B, thus forming two identical rows of grooves and teeth with space there between.

Note that the length of frames 108 and 110 is slightly longer than the length L of the maximum length of the edge of the document sheet to be bound. In an embodiment that can bind documents that are 11 inches on an edge, the frames will therefore be slightly longer than 11 inches. Referring now to FIG. 4, the two frames are secured by straps 402 and 404. Near a left end of the frames, strap 402 is secured at one end to frame 108 by fastening anchor 206. Strap 402 passes over lever block 210 and through rectangular holes 202 and 302. Strap 402 is secured to frame 110 by a latch 410 that mates with latch grooves 310. Similarly, near a right end of the frames, strap 404 is secured at one end to frame 108 by fastening anchor 208. Strap 404 passes over lever block 212 and through rectangular holes 204 and 304. Strap 404 is secured to frame 110 by a latch 412 that mates with latch grooves 312. Straps 402 and 404 are made of a suitable material that will not break under stress. For example, the straps may be made of a stretchable or unstretchable material that is solid or braided.

Frame 110 is affixed to spine 104 of folder 100 by rivets 308 through securing part 306. Papers of length L are bound between the frame faces 201 and 301 by inserting the edge of the papers in the gap G between the frames and between the straps 402 and 404 and then latching latches 410 and 412 into the grooves 310 and 312. When the latches are secured in the grooves, the force of the tightened strap bears inwardly upon lever blocks 210 and 212, applying a force in the direction from frame 108 to frame 110 and a counteracting force in the direction of frame 110 to frame 108. This clamps the edge of the papers between the frames.

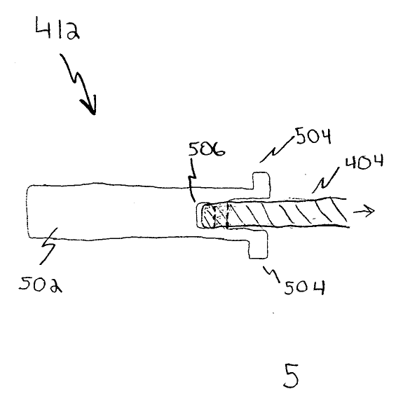

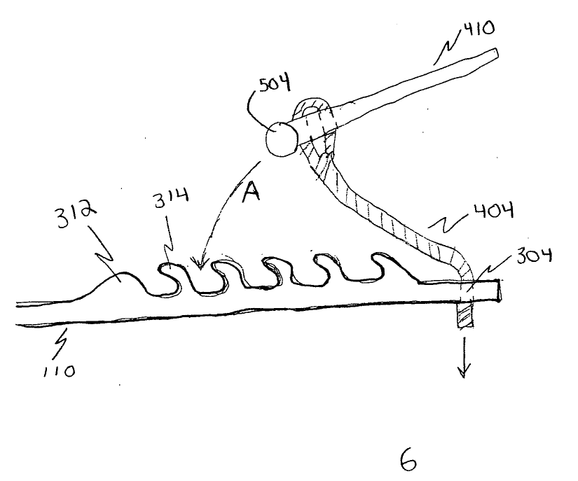

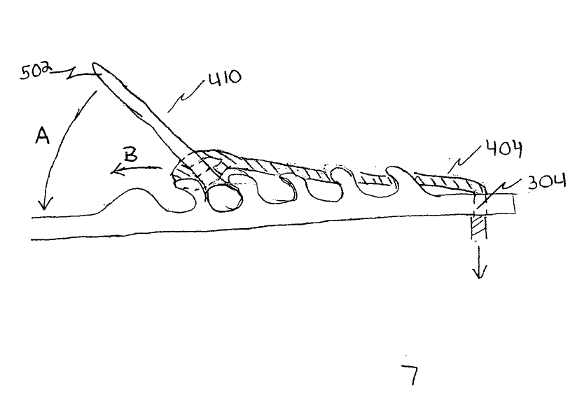

FIG. 5 shows a more detailed top view of a latch 412. Latch 412 operates as a lever exhibiting a lever arm 502 and securing posts 504. Securing posts 504 fit into grooves 312 of frame 110. Strap 404 passes through a hole 506 of latch 412 to secure strap 404 to latch 412. FIG. 6 and FIG. 7 show more detailed side views of how a latch is secured in a set of grooves. FIG. 6 shows strap 404 passing through hole 304 and connecting to latch 410. Securing posts 504 are moved in the direction of arrow A into groove 312 between teeth 314. FIG. 7 shows securing posts 504 of latch 412 inserted into grooves. To secure the latch, the lever arm 502 of latch 512 is pushed in the direction of arrow A so that the lever arm 502 rests between the two rows of grooves 312. This pulls the strap taut in the direction of arrow B. By pulling the straps taut on each side, the strap is tightened against the lever blocks to apply force inward to bind the paper edges inserted between the frames. Thus, by rotating the lever arm, the strap is tightened, the strap is secured to the second frame, and the two frames are forced toward each other to clamp an edge of the papers inserted there between.

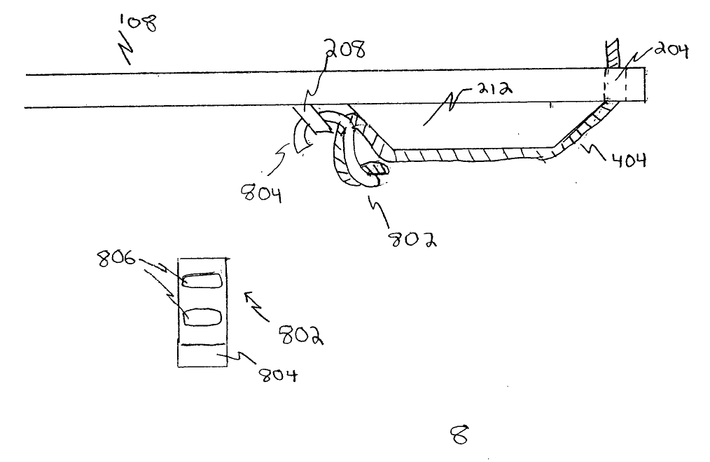

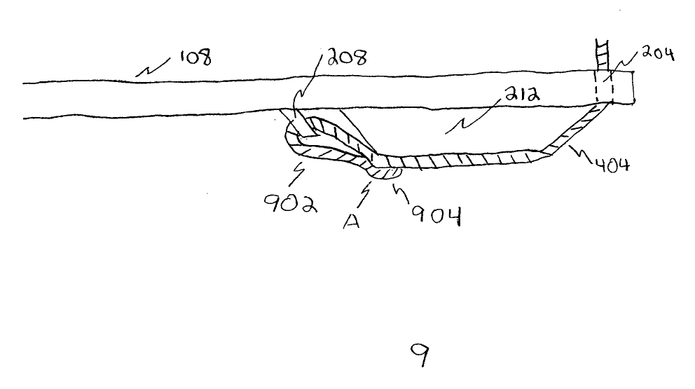

FIG. 8 shows a more detailed side view of the strap attachment and lever block assembly. Strap 404 passes through hole 204, passes adjacent to lever block 212 and is secured at the end to fastening anchor 208. The strap passes through holes 806 of a buckle 802 and the buckle is anchored to fastening anchor 208 by a flat hook part 804 of buckle 802. FIG. 9 shows strap 404 being secured by passing it through fastening anchor 208 and looping 902 the end 904 back and securing the end 904 to the body of the strap itself in region A. This can be done, for example, with glue or Velcro. Persons of ordinary skill will recognize many ways of securing strap 404 to frame 108. The key is that the strap, when latched tight, will apply inward pressure to the lever block to create the clamping effect.

Note that the securing mechanism shown in FIGS. 6 and 7 is reversible. The process of removing the latch 410 is the reverse of the process of securing latch 410. Therefore, loosening the latch in order to release the clamp on the documents so that documents can be removed or added is a simple quick process. And, no holes are required to be punched in the documents.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A paper clamping apparatus for binding papers together for storage and access, comprising:
two opposing frames so situated that an edge of papers may be inserted between facing sides of the frames and clamped between the the frames by a clamping mechanism;
a clamping mechanism to force the first frame toward the second frame so that the frames clamp an edge of the papers inserted between the frames, the clamping mechanism comprising;
a strap secured to the first frame and securable to the second frame;
a lever arm, to which the strap is attached, to tighten the strap connecting the first and second frames; so that rotating the lever arm tightens the strap, secures the strap to the second frame, and forces the two frames toward each other to clamp an edge of the papers inserted between the frames; and
a lever block so situated between the strap and a frame that tightening the strap applies force through the lever block to the frame.

2. The apparatus of claim 1, wherein the lever arm to which the strap is secured fits at an end into a groove affixed to a frame.

3. The apparatus of claim 1, wherein a frame is secured to the spine of a folder.

4. The apparatus of claim 1, wherein the lever arm pivots about an end to apply a force to the strap connected there to.

5. A document binder for binding documents and papers together, comprising:
a first frame and a second frame oriented so that an inward-facing side of the first frame faces an inward-facing side of the second frame, so that an edge of papers to be bound may be inserted between the inward-facing sides of the first and second frames;
a strap secured to the first frame and securable to the second frame; and
a lever arm to tighten the strap connecting the first and second frames; so that rotating the lever arm tightens the strap, secures the strap to the second frame, and forces the two frames toward each other to clamp an edge of the papers inserted between the frames.

6. The binder of claim 7, further comprising a lever block so situated between the strap and a frame that tightening the strap applies force through the lever block to the frame.

7. The apparatus of claim 7, wherein the lever arm to which the strap is secured fits near an end into a groove affixed to a frame.

8. The apparatus of claim 1, wherein a frame is secured to the spine of a folder.

9. A document folder for holding documents and papers with or without punched holes, comprising:
a front cover, a back cover, and a spine to which the front and back covers are connected at their edges;
a first frame and a second frame with facing sides between which an edge of the papers can be inserted, one of the two frames attached to the spine;
a strap secured to the first frame, and passing through a hole in the first frame, and passing through a hole in the second frame, the strap connected to a lever that is securable to the second frame; and
a lever to which the strap is connected, the lever exhibiting posts that mate with grooves in the second frame, the grooves, lever and strap so situated that when the lever is rotated about the posts, the strap is tightened, forcing the frames together.

10. The folder of claim 9, further comprising a lever block so situated between the strap and a frame that tightening the strap applies force through the lever block to the frame.
